(19) United States
(12) Patent Application Publication
(10) Pub. No.: US 2025/0317805 A1
(43) Pub. Date: Oct. 9, 2025

(54) Transmission Rate Decision Method and Related System

(71) Applicant: Realtek Semiconductor Corp., HsinChu (TW)

(72) Inventors: Wun-Ci Su, HsinChu (TW); Shau-Yu Cheng, HsinChu (TW); Chun-Kai Tseng, HsinChu (TW)

(73) Assignee: Realtek Semiconductor Corp, HsinChu (TW)

(21) Appl. No.: 18/951,605

(22) Filed: Nov. 18, 2024

(30) Foreign Application Priority Data
Apr. 3, 2024 (TW) 113112666

(51) Int. Cl. H04W 28/22; H04W 28/02; H04W 28/08

(52) U.S. Cl. CPC H04W 28/22; H04W 28/0268; H04W 28/0975

(57) ABSTRACT

A transmission rate decision method, for a wireless transmission system that adopts a latency strategy, the transmission rate decision method comprises (a) at a first time point, obtaining a first packet error rate and a first transmission rate corresponding to a first current scene of the wireless transmission system; (b) at the first time point, determining a first candidate packet error rate according to a first candidate transmission rate corresponding to a first candidate scene of the wireless transmission system; and (c) determining a second transmission rate at a second time point according to the first packet error rate, the first transmission rate, the first candidate packet error rate and the first candidate transmission rate; wherein the wireless transmission system performs a wireless transmission using the second transmission rate at the second time point; wherein the second time point lags behind the first time point.

### BACKGROUND OF THE INVENTION

### 1. Field of the Invention

The present invention relates to a transmission rate decision method and a system thereof, and more particularly, to a transmission rate decision method and a system that adopt a latency strategy.

### 2. Description of the Prior Art

With the advancement of technology, the transmission end in most wireless scenes needs to serve users who use various types of applications at the same time. For example, in a wireless scene of a home network, a user A simultaneously conducts video conferencing and web browsing, and a user B simultaneously conducts online games and live broadcasting. In this circumstance, the wireless communication transmission technology in the wireless scene uses the Orthogonal Frequency-Division Multiple Access (OFDMA) technology and the spatial reuse (SR) mechanism, so that the transmission end in the wireless scene can support multiple user devices to transmit simultaneously and improve spectrum utilization.

In a wireless communication transmission system, a rate adaptation (RA) mechanism may determine a transmission rate for users in wireless scenarios such as a single user (SU) mode, a multi user (MU) mode, a spatial reuse (SR) mode and a resource unit (RU) mode. In addition, in the above wireless scenarios, the users may have high throughput, low power consumption and low latency requirements. Therefore, when the wireless communication transmission system adopts a throughput (TP) strategy, a stability strategy and a latency strategy, the adaptive transmission rate mechanism should be redesigned. Under this circumstance, how to improve the transmission rate decision method has become one of the goals in the industry.

### SUMMARY OF THE INVENTION

The present invention is to provide a transmission rate decision method and a system thereof to solve the above problems.

The present invention provides a transmission rate decision method, for a wireless transmission system that adopts a latency strategy, the transmission rate decision method including (a) at a first time point, obtaining a first packet error rate and a first transmission rate corresponding to a first current scene of the wireless transmission system; (b) at the first time point, determining a first candidate packet error rate according to a first candidate transmission rate corresponding to a first candidate scene of the wireless transmission system; and (c) determining a second transmission rate at a second time point according to the first packet error rate, the first transmission rate, the first candidate packet error rate and the first candidate transmission rate; wherein the wireless transmission system performs a wireless transmission using the second transmission rate at the second time point; wherein the second time point lags behind the first time point.

The present invention provides an access point, configured in a wireless transmission system that adopts a latency strategy, the access point including a processor; and a memory, coupled to the processor, configured to store a program code for instructing the processor to execute a transmission rate decision method, wherein the transmission rate decision method comprises: (a) at a first time point, obtaining a first packet error rate and a first transmission rate corresponding to a first current scene of the wireless transmission system; (b) at the first time point, determining a first candidate packet error rate according to a first candidate transmission rate corresponding to a first candidate scene of the wireless transmission and (c) determining system; a second transmission rate at a second time point according to the first packet error rate, the first transmission rate, the first candidate packet error rate and the first candidate transmission rate; wherein the wireless transmission system performs a wireless transmission using the second transmission rate at the second time point; wherein the second time point lags behind the first time point.

The present invention provides a user device, for a wireless transmission system that adopts a latency strategy, the user device including a wireless communication module; and a memory, coupled to the wireless communication module, configured to store a program code for instructing the wireless communication module to execute the following steps: obtaining a second transmission rate at a second time point from an access point of the wireless transmission system at a first time point; and performing a wireless transmission using the second transmission rate with the access point at the second time point; wherein the second transmission rate is determined by the access point using a transmission rate decision method, the transmission rate decision method comprises: (a) at a first time point, obtaining a first packet error rate and a first transmission rate corresponding to a first current scene of the wireless transmission system; (b) at the first time point, determining a first candidate packet error rate according to a first candidate transmission rate corresponding to a first candidate scene of the wireless transmission system; (c) determining and a second transmission rate at a second time point according to the first packet error rate, the first transmission rate, the first candidate packet error rate and the first candidate transmission rate; wherein the second time point lags behind the first time point.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless transmission system according to an embodiment of the present invention.

FIG. 2 is a flowchart of a transmission parameter decision method according to an embodiment of the present invention.

FIG. 3 is a schematic diagram of a transmission parameter decision method according to an embodiment of the present invention.

FIG. 4 is a schematic diagram of a transmission parameter decision method according to another embodiment of the present invention.

FIG. 5 is a schematic diagram of the deep neural network according to an embodiment of the present invention.

FIG. 6 is a schematic diagram of a transmission parameter decision method according to an embodiment of the present invention.

FIG. 7 is a flowchart of a transmission parameter decision method according to an embodiment of the present invention.

FIG. 8 is a schematic diagram of a low latency transmission rate module pool according to an embodiment of the present invention.

FIG. 9 is a flowchart of a transmission parameter decision method according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

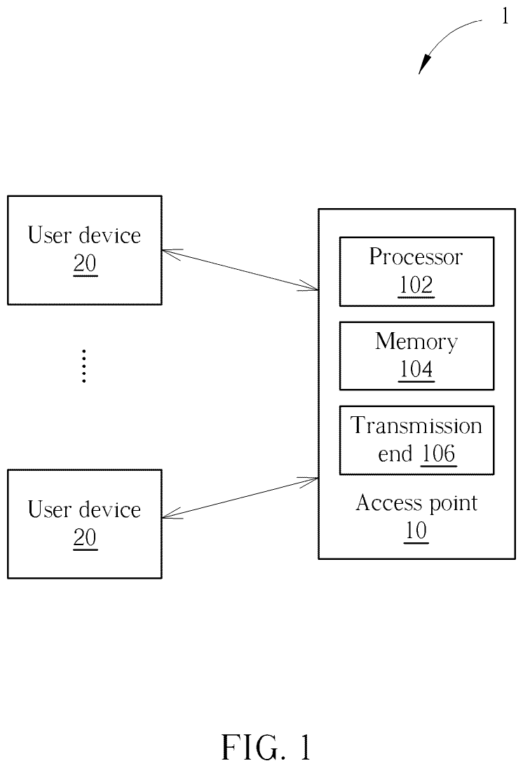

Please refer to FIG. 1. FIG. 1 is a schematic diagram of a wireless transmission system 1 according to an embodiment of the present invention. The wireless transmission system 1 includes an access point (AP) 10 and a plurality of user devices 20. The access point 10 includes a processor 102, a memory 104 and a transmission end 106. The memory 104 stores a program code for instructing the processor 102 to execute a transmission parameter decision method for deciding the plurality of transmission parameters. During the next transmission, the plurality of user devices 20 may perform the wireless transmission with the transmission end 106 of the access point 10 according to the plurality of transmission parameters. The plurality of user devices 20 may include a mobile device, a notebook computer and a smart home appliance, etc., but not limited thereto. Specifically, the plurality of transmission parameters may include a transmission rate, a transmission mode and a transmission power, wherein the transmission rate is a connection rate of each user device during the next transmission; the transmission mode represents a plurality of modes corresponding to various wireless scenes during the next transmission, e.g., Orthogonal Frequency-Division Multiple Access (OFDMA) and Spatial Reuse (SR) mechanism, etc., but not limited thereto; the transmission power is a connection power for the next transmission.

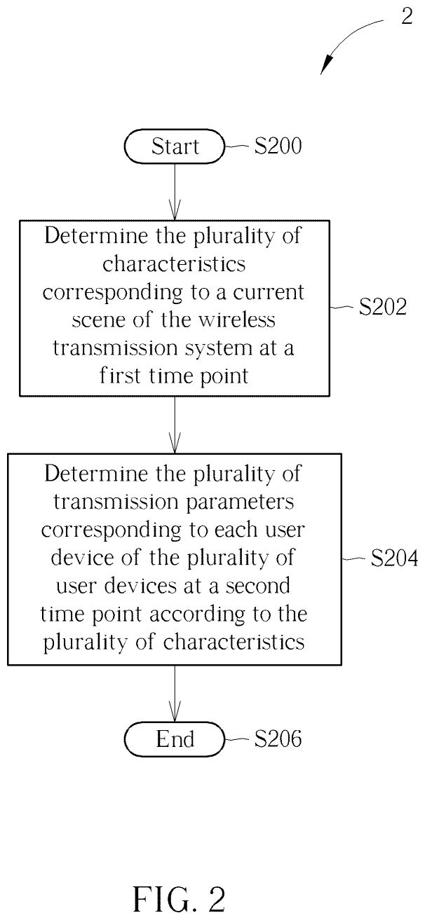

The transmission parameter decision method of the wireless transmission system 1 may be summarized as a process 2, as shown in FIG. 2. The process 2 includes the following steps:

Step S200: Start.

Step S202: Determine the plurality of characteristics corresponding to a current scene of the wireless transmission system at a first time point.

Step S204: Determine the plurality of transmission parameters corresponding to each user device of the plurality of user devices at a second time point according to the plurality of characteristics. Step S206: End.

According to the process 2, in the step S202, the processor 102 of the access point 10 may determine the plurality of characteristics corresponding to a current scene of the wireless transmission system. The plurality of characteristics may include a user number, a traffic distribution, a category queue, a channel state information (CSI) and a packet error rate (PER). Specifically, the processor 102 may determine the user number that the transmission end 106 needs to serve in a current queue, obtain the traffic distribution from the statistics of data flowing into the current queue, obtain a priority order of an upper-layer application services entering different category queue according to the different quality of service (QoS), obtain the channel state information using to evaluate the transmission mode adopted by the user device, and obtain a packet error rate according to each transmission result. It should be noted that the plurality of characteristics of a current scene of the wireless transmission system only represent t necessary features required to implement the transmission parameter decision method. The basic meanings of the plurality of characteristics are well known in the art, and will not be narrated for brevity. Those skilled in the art may add other features as needed to determine the transmission parameters.

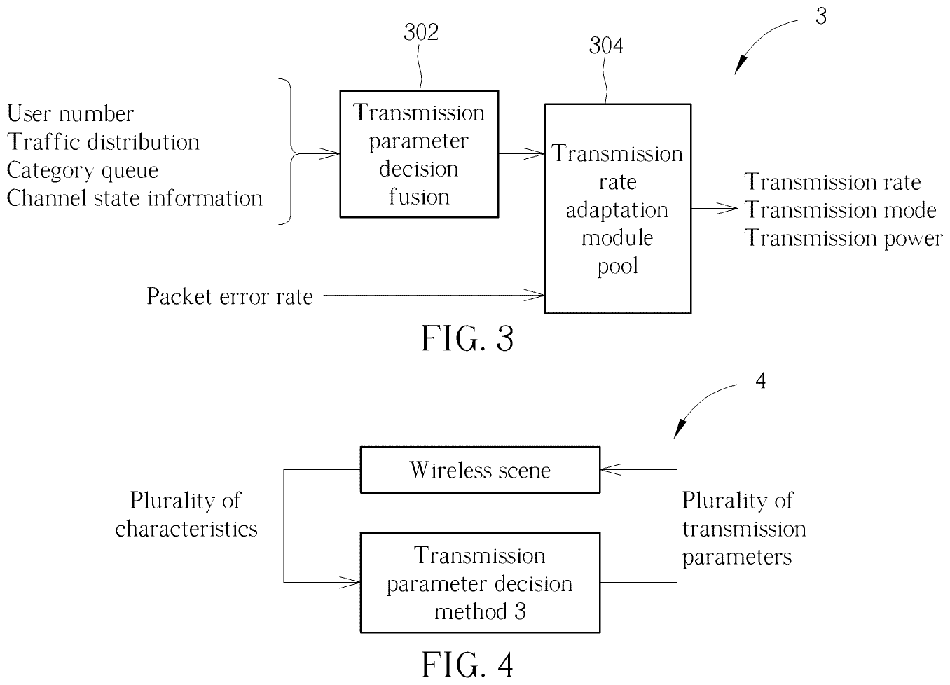

In step S204, the processor 102 of the access point 10 may determine the plurality of transmission parameters of each user device corresponding to a plurality of user devices at the second time point according to the plurality of characteristics. It should be noted that the second time point lags behind the first time point. For example, the first time point is a current time point, and the second time point is a time point of the next transmission, or the second time point is a time point of a future transmission. Specifically, please refer to FIG. 3. FIG. 3 is a schematic diagram of a transmission parameter decision method 3 according to an embodiment of the present invention. The processor 102 may perform a transmission parameter decision fusion 302 according to the user number, the traffic distribution, the category queue and the channel state information, so as to generate the plurality of transmission modes and the plurality of transmission strategies suitable for current scene. The plurality of transmission modes include a single user (SU) mode, a multi user (MU) mode, a spatial reuse (SR) mode and a resource unit (RU) mode. The plurality of transmission strategies include a throughput (TP) strategy, a stability strategy and a latency strategy. Furthermore, the processor 102 may determine the plurality of transmission parameters by a transmission rate adaptation module pool 304 according to the packet error rate, the plurality of transmission modes and the plurality of transmission strategies, so as to provide to each user device of the plurality of user devices to perform the wireless transmission at the second time point with the access point 10, respectively. In other words, each user device of the plurality of user devices may perform the wireless transmission with the access point 10 according to various transmission parameters. In this way, the embodiment of the present invention may improve the transmission efficiency between each user device of the plurality of user devices and the access point 10, and improve a spectrum utilization rate of the wireless transmission.

It should be noted that, since the scenes of the wireless transmission at different time points may change, and the transmission parameter decision method 3 only determines the plurality of transmission parameters suitable for the current scene according to the plurality of characteristics of the current scene (the first time point). Therefore, the present invention may also use a Markov decision process (MDP) in combination with the transmission parameter decision method 3 to determine the plurality of transmission parameters of various scenes of the wireless transmission. For example, please refer to FIG. 4. FIG. 4 is a schematic diagram of a transmission parameter decision method 4 according to an embodiment of the present invention. Specifically, since the plurality of transmission parameters determined by the transmission parameter decision method 3 at the first time point may be used for the transmission at the second time point, and may affect the wireless scene at the second time point, the transmission parameter decision method 4 may re-determine the plurality of transmission parameters of the wireless scene corresponding to the next time point at the second time point according to the plurality of characteristics corresponding to the second time point. In this way, the transmission parameter decision method 4 may provide the best benefit decision in changing wireless scenes.

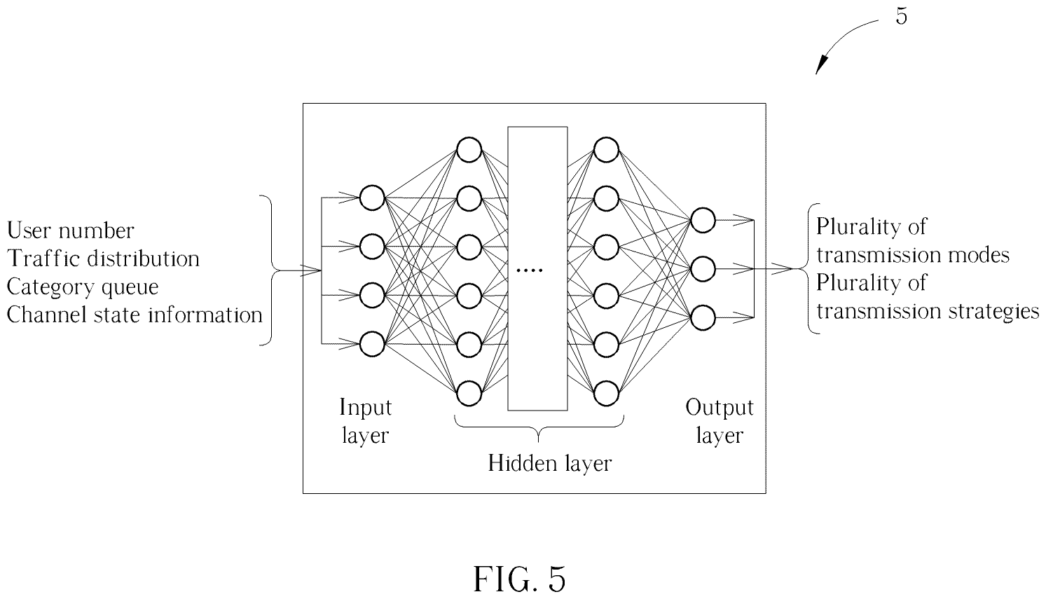

In an embodiment, the transmission parameter decision fusion 302 may use a deep learning method or a reinforcement learning method to determine the plurality of transmission modes and the plurality of transmission strategies in complex wireless scenes. For example, the transmission parameter decision fusion 302 may use a deep neural network (DNN) 5, and FIG. 5 is a schematic diagram of the deep neural network 5 according to an embodiment of the present invention. The deep neural network 5 includes an input layer, a hidden layer and an output layer. The processor 102 may input the user number, the traffic distribution, the category queue and the channel state information to the input layer, and obtain the plurality of transmission modes and the plurality of transmission strategies from the output layer. In this way, the processor 102 may determine the plurality of transmission parameters from the transmission rate adaptation module pool 304 according to the packet error rate, the plurality of transmission modes and the plurality of transmission strategies, so as to provide to each user device of the plurality of user devices to perform the wireless transmission with the access point 10 at the second time point. It should be noted that, the operation of the deep neural network is well known in the art, and will not be narrated for brevity. In addition, the deep learning method or the reinforcement learning method may also use a deep belief network (DBN), a convolutional neural network (CNN) and a convolutional deep belief (CDBN) architecture, but will not be limited thereto.

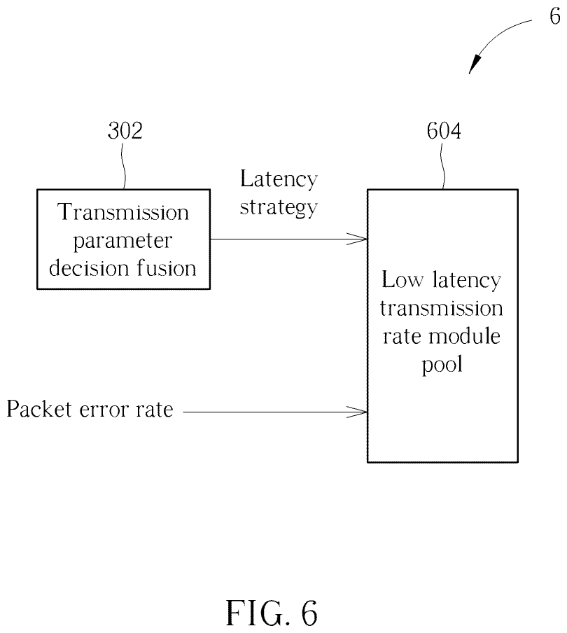

It should be noted that, the transmission parameter decision method 3 is the embodiment of the present invention, and those skilled in the art may make appropriate adjustments according to the system requirements. For example, in an embodiment, as shown in FIG. 6. FIG. 6 is a schematic diagram of a transmission parameter decision method 6 according to an embodiment of the present invention. The transmission parameter decision method 6 is derived from the transmission parameter decision method 3, so the elements are represented by the same symbols. The difference between the transmission parameter decision method 6 and the transmission parameter decision method 3 is that the processor 102 performs the transmission parameter decision fusion 302 according to the user number, the traffic distribution, the category queue and the channel state information and determines that the wireless transmission system 1 adopts the latency strategy for the wireless transmission. Therefore, the processor 102 may determine the transmission rate from a low latency transmission rate module pool 604 according to the packet error rate and the latency strategy to provide each user device of the plurality of user devices to perform the wireless transmission with the access point 10 with low latency characteristics at the second time point. Specifically, the low latency characteristics are related to a queue time, a contention backoff time, a MAC processing time (for example, the fixed time intervals such as AIFS, SIFS, etc.) and an air TX time after the upper layer generates the data packets. The queue time and the transmission time are the main influencing factors of the low latency characteristics. Therefore, the low latency transmission rate module pool 604 of the transmission parameter decision method 6 of the present invention achieves the wireless transmission with the low latency characteristics by reducing the number of retransmissions of the wireless transmission system 1 or increasing the transmission opportunities of the wireless transmission system 1. It should be noted that, in the embodiment, the plurality of transmission modes generated by the transmission parameter decision fusion 302 may be the single user mode, the multi user mode, the spatial reuse mode or the resource unit mode, but not limited thereto.

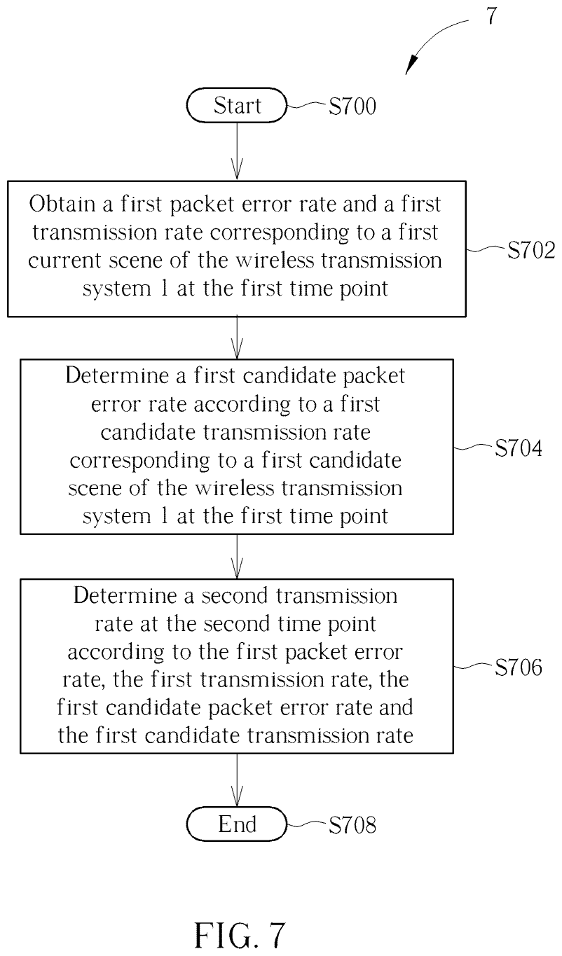

Specifically, in order to reduce the number of retransmission of the wireless transmission system 1, the present invention utilizes the low latency transmission rate module pool 604 to control the packet error rate to reduce the number of retransmission. The transmission parameter decision method 6 for the wireless transmission system 1 that adopts the latency strategy may be summarized as a process 7, as shown in FIG. 7. The process 7 includes the following steps:

Step S700: Start.

Step S702: Obtain a first packet error rate and a first transmission rate corresponding to a first current scene of the wireless transmission system 1 at the first time point.

Step S704: Determine a first candidate packet error rate according to a first candidate transmission rate corresponding to a first candidate scene of the wireless transmission system 1 at the first time point.

Step S706: Determine a second transmission rate at the second time point according to the first packet error rate, the first transmission rate, the first candidate packet error rate and the first candidate transmission rate.

Step S708: End.

According to the process 7, in step S702, the processor 102 of the access point 10 may obtain a first packet error rate and a first transmission rate corresponding to a first current scene of the wireless transmission system 1 at the first time point. In detail, the processor 102 may obtain the channel state information used to evaluate the transmission mode adopted by the user device, and obtain the first packet error rate according to the transmission result of the wireless transmission at the first transmission rate in the first current scene.

In step S704, the processor 102 of the access point 10 may determine the first candidate packet error rate according to the first candidate transmission rate corresponding to the first candidate scene of the wireless transmission system 1 at the first time point. In detail, the memory 104 stores a first lookup table corresponding to the plurality of first candidate transmission rates of the plurality of first candidate scenes. It should be noted that, the processor 102 may offline simulate various transmission parameters corresponding to the each first candidate scene to establish the first lookup table. As shown in Table 1, when the first current scene is 2ss/MCS11/BW80, the first candidate scene 1 is 2ss/MCS10/BW80, wherein ss represents the number of the antennas, MCS represents the modulation coding method, BW represents the transmission bandwidth. It should be noted that, the number of the antennas and the modulation coding method are related to the transmission rate. For example, the transmission rate is faster in the scene with a larger number of the antennas or in the scene with higher exponential modulation coding method. In other words, the first candidate transmission rate corresponding to each first candidate scene in Table 1 is smaller than the first transmission rate corresponding to the first current scene. In this way, the processor 102 selects a better or best first candidate scene from the plurality of first candidate scenes in the first lookup table according to the first current scene, and determines the first candidate packet error rate of the selected first candidate scene. It should be noted that, for convenience of description, the following description uses the selected better or best first candidate scene as example.

TABLE 1

| first | first | first | first |
|---|---|---|---|
| current | candidate | candidate | candidate |
| scene | scene 1 | scene 2 | scene 3 |
| 2ss/MCS11/BW80 | 2ss/MCS10/BW80 | 1ss/MCS9/BW80 | . . . |
| 2ss/MCS10/BW80 | 2ss/MCS9/BW80 | 1ss/MCS8/BW80 | . . . |
| . . . | . . . | . . . | . . . |

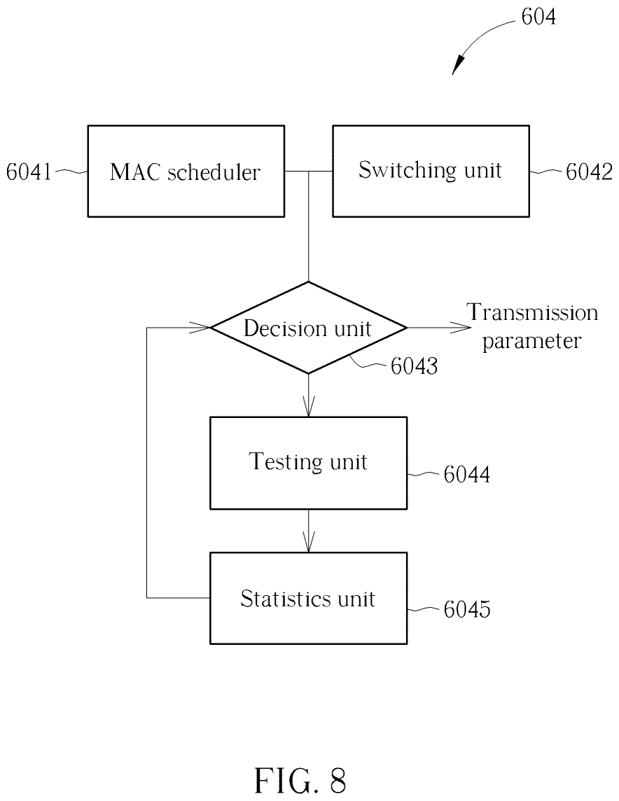

In step S706, the processor 102 of the access point 10 may determine the second transmission rate corresponding to each user device of the plurality of user devices at the second time point according to the first packet error rate, the first transmission rate, the first candidate packet error rate and the first candidate transmission rate. It should be noted that the second time point lags behind the first time point. For example, the first time point is a current time point, the second time point is a time point of the next transmission, or the second time point is a time point of the future transmission. In detail, please refer to FIG. 8. FIG. 8 is a schematic diagram of the low latency transmission rate module pool 604 according to an embodiment of the present invention. As shown in FIG. 8, the low latency transmission rate module pool 604 includes a MAC scheduler 6041, a switching unit 6042, a decision unit 6043, a testing unit 6044 and a statistics unit 6045. The MAC scheduler 6041 may assign different transmission priorities to the plurality of transmission strategies. The latency strategy of the plurality of transmission strategies has the highest transmission priority, and the MAC scheduler 6041 schedules the packet transmission sequence in the queue according to the transmission priority to reduce the queue time. The switching unit 6042 may enable the decision unit 6043, the testing unit 6044 and the statistics unit 6045 of the low latency transmission rate module pool 604 when determining that the latency strategy is adopted according to the plurality of transmission strategies. The statistics unit 6045 may collect the transmission results of each wireless transmission. For example, the statistics unit 6045 obtains the first packet error rate and the first transmission rate of the first current scene. The testing unit 6044 may select the better or best first candidate scene and the corresponding first candidate transmission rate in Table 1, and determine the first candidate packet error rate corresponding to the first candidate scene. The decision unit 6043 may receive the first packet error rate, the first transmission rate from the statistics unit 6045 and the first candidate transmission rate, the first candidate packet error rate from the testing unit 6044, and determine the second transmission rate at the second time point accordingly.

In detail, the decision unit 6043 calculates a first throughput according to the first packet error rate and the first transmission rate, and calculates a first candidate throughput according to the first candidate packet error rate and the first candidate transmission rate, as shown in equation 1 and equation 2:

$${TP}_{I , 0} = {R}_{I , 0} \times {x}_{0} {PER}_{0} \qquad ( 1 )$$

$${TP}_{I , 1} = {R}_{1} \times {x}_{1} {PER}_{1} \qquad ( 2 )$$

wherein TP_{I,0} represents the first throughput; TP_{I,1} represents the first candidate throughput; R_{I,0} represents the first transmission rate; R_{I,1} represents the first candidate transmission rate; PER₀ represents the first packet error rate; PER₁ represents the first candidate packet error rate; x₀ represents a first packet error rate weight; x₁ represents a first candidate packet error rate weight.

In this way, the decision unit 6043 may compare the first throughput with the first candidate throughput to determine the second transmission rate at the second time point. For example, when the first throughput is greater than the first candidate throughput, the decision unit 6043 determines that the second transmission rate is equal to the first transmission rate; and when the first throughput is smaller than or equal to the first candidate throughput, the decision unit 6043 determines that the second transmission rate is equal to the first candidate transmission rate.

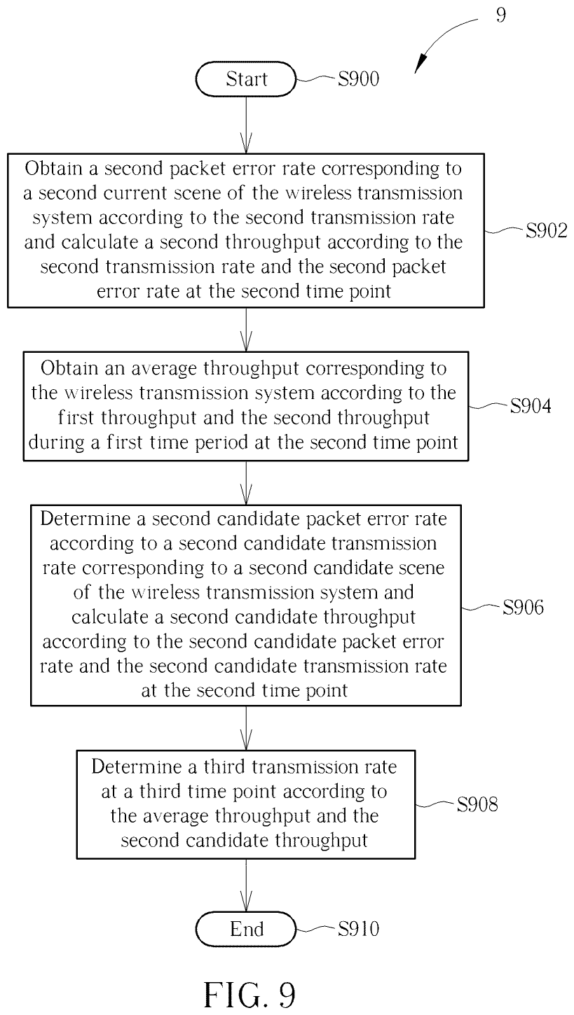

In addition, when the wireless transmission system 1 is in a low throughput state, the present invention utilizes the low latency transmission rate module pool 604 to control the transmission bandwidth to increase the transmission opportunities. The transmission parameter decision method 6 for the wireless transmission system 1 that adopts the latency strategy may be summarized as a process 9, as shown in FIG. 9. The process 9 includes the following steps:

Step S900: Start.

Step S902: Obtain a second packet error rate corresponding to a second current scene of the wireless transmission system according to the second transmission rate and calculate a second throughput according to the second transmission rate and the second packet error rate at the second time point.

Step S904: Obtain an average throughput corresponding to the wireless transmission system according to the first throughput and the second throughput during a first time period at the second time point.

Step S906: Determine a second candidate packet error rate according to a second candidate transmission rate corresponding to a second candidate scene of the wireless transmission system and calculate a second candidate throughput according to the second candidate packet error rate and the second candidate transmission rate at the second time point.

Step S908: Determine a third transmission rate at a third time point according to the average throughput and the second candidate throughput.

Step S910: End.

According to the process 9, in step S902, the processor 102 of the access point 10 may obtain the second packet error rate corresponding to the second current scene of the wireless transmission system 1 at the second time point according to the second transmission rate determined from step S706. In detail, the processor 102 may obtain the channel state information utilized to evaluate the transmission mode adopted by the user device, and obtain the second packet error rate according to the transmission result of the wireless transmission with the second transmission rate in the second current scene.

In step S904, the processor 102 of the access point 10 may obtain an average throughput corresponding to the wireless transmission system during a first time period at the second time point according to the first throughput and the second throughput. It should be noted that the first time period starts at the first time point and ends at the second time point. In an embodiment, the average throughput may be an average of the first throughput and the second throughput. In another embodiment, the average throughput may be an average of the average of the throughput corresponding to every time period before the first time period and the second throughput. As shown in Equation 3, but is not limited thereto. It should be noted that the low throughput state may indicate that the average throughput is smaller than a throughput threshold, or indicate that the first throughput and the first candidate throughput are both smaller than a throughput threshold, but are not limited thereto.

$${TP}_{AVG , 1} = ( 1 - α ) {TP}_{AVG , 0} + α {TP}_{I , 1} \qquad ( 3 )$$

wherein TP_{AVG,1} represents the average throughput corresponding to the first time period; TP_{AVG,0} represents the average throughput corresponding to every time period before the first time period; TP_{I,1} represents the second throughput; α represents a throughput weight.

In step S906, the processor 102 of the access point 10 may determine a second candidate packet error rate according to a second candidate transmission rate corresponding to a second candidate scene of the wireless transmission system, and calculate a second candidate throughput according to the second candidate packet error rate and the second candidate transmission rate at the second time point. In detail, the memory 104 stores a second lookup table of the plurality of second candidate transmission rate corresponding to the plurality of second candidate scenes. It should be noted that the processor 102 may offline simulate various transmission parameters corresponding to the each second candidate scene to establish the second lookup table. As shown in Table 2, when the second current scene is 2ss/MCS11/BW80, the second candidate scene 1 is 1ss/MCS11/BW80, where ss represents the number of the antennas, MCS represents the modulation coding method, and BW represents the transmission bandwidth. It should be noted that the number of the antennas and the modulation coding method are related to the transmission rate. For example, the transmission rate is faster in the scene with a larger number of the antennas or in the scene with higher exponential modulation coding method. In other words, the second candidate transmission rate corresponding to each second candidate scene in Table 2 is smaller than the second transmission rate of the second current scene, or the second candidate transmission rate corresponding to each second candidate scene is smaller than the first transmission rate of the first current scene and the second candidate transmission bandwidth corresponding to each second candidate scene is smaller than or equal to the second transmission bandwidth of the second current scene. In this way, the processor 102 selects a better or best second candidate scene from the plurality of second candidate scenes in the second lookup table according to the second current scene, and determines the second candidate packet error rate of the selected second candidate scene. It should be noted that, for convenience of description, the following description uses the selected better or best second candidate scene as example.

TABLE 2

| second current | second candidate | second candidate | second candidate |
|---|---|---|---|
| scene | scene 1 | scene 2 | scene 3 |
| 2ss/MCS11/BW80 | 1ss/MCS11/BW80 | 1ss/MCS11/BW40 | 1ss/MCS11/BW20 |
| 2ss/MCS10/BW80 | 1ss/MCS10/BW80 | 1ss/MCS10/BW40 | 1ss/MCS10/BW20 |
| . . . | . . . | . . . | . . . |

In step S908, the processor 102 of the access point 10 may determine the third transmission rate corresponding to each user device of the plurality of user devices of the third time point according to the average throughput and the second candidate throughput. It should be noted that the third time point lags behind the second time point. In detail, the testing unit 6044 may select the better or best the second candidate scene and corresponding second candidate transmission rate in Table 2, and determine the second candidate packet error rate corresponding to the second candidate scene. The statistics unit 6045 may collect the transmission results (for example, the average throughput of the first time period or the average throughput of each time period before the first time period) of every wireless transmission. The decision unit 6043 may receive the average throughput from the statistics unit 6045 and the second candidate transmission rate, the second candidate packet error rate from the testing unit 6044, and determine the third transmission rate of the third time point accordingly.

In detail, the decision unit 6043 calculates a second candidate throughput according to the second candidate packet error rate and the second candidate transmission rate, as shown in Equation 4:

$${TP}_{I , 2} = {R}_{I , 2} \times {x}_{2} {PER}_{2} \qquad ( 4 )$$

wherein TP_{I,2} represents the second candidate throughput; R_{I,2} represents the second candidate transmission rate; PER₂ represents the second candidate packet error rate; x₂ is a second candidate packet error rate weight.

In this way, the decision unit 6043 may compare the average throughput with the second candidate throughput to determine the third transmission rate of the third time point. For example, in an embodiment, when the average throughput is greater than the second candidate throughput, the decision unit 6043 determines that the third transmission rate is equal to the second transmission rate; and when the average throughput is smaller than or equal to the second candidate throughput, the decision unit 6043 determines that the third transmission rate is equal to the second candidate transmission rate. It should be noted that, those skilled in the art may make appropriate adjustments according to the system requirements to determine the third transmission rate. For example, in another embodiment, when the average throughput meets the condition of Equation 5, the decision unit 6043 determines that the third transmission rate is equal to the second transmission rate; and when the average throughput meets the condition of Equation 6, the decision unit 6043 determines that the third transmission rate is equal to the second candidate transmission rate.

$${TP}_{AVG , 0} > {η}_{0} {TP}_{I , 2} \qquad ( 5 )$$

$${TP}_{AVG , 0} \leq {η}_{0} {TP}_{I , 2} \qquad ( 6 )$$

wherein TP_{AVG,0} represents the average throughput corresponding to each time period before the first time period; TP_{I,2} represents the second throughput; η₀ represents a throughput conversion rate (η₀=TP_{AVG,0}/TP_{I,0}).

It should be noted that the wireless transmission system 1 is an embodiment of the present invention. Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on module (CoM) and the electronic system. Any of the abovementioned procedures and examples above may be compiled into program codes or instructions that are stored in the memory 104. The memory 104 may include read-only memory (ROM), flash memory, random access memory (RAM), subscriber identity module (SIM), hard disk, or CD-ROM/DVD-ROM/BD-ROM, but not limited thereto. The processor 102 may read and execute the program codes or the instructions stored in the memory 104 for realizing the abovementioned functions.

In summary, compared with the prior art, the wireless transmission system and the transmission parameter decision method of the present invention adopting the latency strategy may quickly find a suitable transmission rate by reducing the number of retransmission and increasing the transmission opportunities, and achieve the wireless transmission with the low latency characteristics.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission rate decision method, for a wireless transmission system that adopts a latency strategy, the transmission rate decision method comprising:
(a) at a first time point, obtaining a first packet error rate and a first transmission rate corresponding to a first current scene of the wireless transmission system;
(b) at the first time point, determining a first candidate packet error rate according to a first candidate transmission rate corresponding to a first candidate scene of the wireless transmission system; and
(c) determining a second transmission rate at a second time point according to the first packet error rate, the first transmission rate, the first candidate packet error rate and the first candidate transmission rate;
wherein the wireless transmission system performs a wireless transmission using the second transmission rate at the second time point;
wherein the second time point lags behind the first time point.

2. The transmission rate decision method of claim 1, wherein the step (c) further comprises:
calculating a first throughput according to the first packet error rate and the first transmission rate;
calculating a first candidate throughput according to the first candidate packet error rate and the first candidate transmission rate; and
determining the second transmission rate at the second time point according to the first throughput and the first candidate throughput.

3. The transmission rate decision method of claim 2, wherein the step (c) further comprises:
determining that the second transmission rate is equal to the first transmission rate when the first throughput is greater than the first candidate throughput; and
determining that the second transmission rate is equal to the first candidate transmission rate when the first throughput is less than or equal to the first candidate throughput.

4. The transmission rate decision method of claim 1, wherein the first candidate transmission rate is smaller than the first transmission rate.

5. The transmission rate decision method of claim 3, wherein when the first throughput and the first candidate throughput are both less than a threshold, the transmission rate decision method further comprises:
(d) obtaining a second packet error rate corresponding to a second current scene of the wireless transmission system according to the second transmission rate and calculating a second throughput according to the second transmission rate and the second packet error rate at the second time point;
(e) obtaining an average throughput during a first time period corresponding to the wireless transmission system according to the first throughput and the second throughput at the second time point, wherein the first time period starts at the first time point and ends at the second time point;
(f) determining a second candidate packet error rate according to a second candidate transmission rate corresponding to a second candidate scene of the wireless transmission system and calculating a second candidate throughput according to the second candidate packet error rate and the second candidate transmission rate at the second time point; and
(g) determining a third transmission rate according to the average throughput and the second candidate throughput at a third time point;
wherein the wireless transmission system performs a wireless transmission using the third transmission rate at the third time point;
wherein the third time point lags behind the second time point.

6. The transmission rate decision method of claim 5, wherein the step (g) further comprises:
determining that the third transmission rate is equal to the second transmission rate when the average throughput is greater than the second candidate throughput; and
determining that the third transmission rate is equal to the second candidate transmission rate when the average throughput is less than or equal to the second candidate throughput.

7. The transmission rate decision method of claim 5, wherein the second candidate transmission rate is smaller than the second transmission rate, and a second candidate transmission bandwidth corresponding to the second candidate scene is smaller than a second transmission bandwidth corresponding to the second current scene.

8. An access point, configured in a wireless transmission system that adopts a latency strategy, the access point comprising:
a processor; and
a memory, coupled to the processor, configured to store a program code for instructing the processor to execute a transmission rate decision method, wherein the transmission rate decision method comprises:
(a) at a first time point, obtaining a first packet error rate and a first transmission rate corresponding to a first current scene of the wireless transmission system;
(b) at the first time point, determining a first candidate packet error rate according to a first candidate transmission rate corresponding to a first candidate scene of the wireless transmission system; and
(c) determining a second transmission rate at a second time point according to the first packet error rate, the first transmission rate, the first candidate packet error rate and the first candidate transmission rate;
wherein the wireless transmission system performs a wireless transmission using the second transmission rate at the second time point;
wherein the second time point lags behind the first time point.

9. The access point of claim 8, wherein the step (c) further comprises:
calculating a first throughput according to the first packet error rate and the first transmission rate;
calculating a first candidate throughput according to the first candidate packet error rate and the first candidate transmission rate; and
determining the second transmission rate at the second time point according to the first throughput and the first candidate throughput.

10. The access point of claim 9, wherein the step (c) further comprises:
determining that the second transmission rate is equal to the first transmission rate when the first throughput is greater than the first candidate throughput; and
determining that the second transmission rate is equal to the first candidate transmission rate when the first throughput is less than or equal to the first candidate throughput.

11. The access point of claim 8, wherein the first candidate transmission rate is smaller than the first transmission rate.

12. The access point of claim 10, wherein when the first throughput and the first candidate throughput are both less than a threshold, the transmission rate decision method further comprises:
(d) obtaining a second packet error rate corresponding to a second current scene of the wireless transmission system according to the second transmission rate and calculating a second throughput according to the second transmission rate and the second packet error rate at the second time point;
(e) obtaining an average throughput during a first time period corresponding to the wireless transmission system according to the first throughput and the second throughput at the second time point, wherein the first time period starts at the first time point and ends at the second time point;
(f) determining a second candidate packet error rate according to a second candidate transmission rate corresponding to a second candidate scene of the wireless transmission system and calculating a second candidate throughput according to the second candidate packet error rate and the second candidate transmission rate at the second time point; and
(g) determining a third transmission rate according to the average throughput and the second candidate throughput at a third time point;
wherein the wireless transmission system performs a wireless transmission using the third transmission rate at the third time point;
wherein the third time point lags behind the second time point.

13. The access point of claim 12, wherein the step (g) further comprises:
determining that the third transmission rate is equal to the second transmission rate when the average throughput is greater than the second candidate throughput; and
determining that the third transmission rate is equal to the second candidate transmission rate when the average throughput is less than or equal to the second candidate throughput.

14. The access point of claim 12, wherein the second candidate transmission rate is smaller than the second transmission rate, and a second candidate transmission bandwidth corresponding to the second candidate scene is smaller than a second transmission bandwidth corresponding to the second current scene.

15. A user device, for a wireless transmission system that adopts a latency strategy, the user device comprising:
a wireless communication module; and
a memory, coupled to the wireless communication module, configured to store a program code for instructing the wireless communication module to execute the following steps:
obtaining a second transmission rate at a second time point from an access point of the wireless transmission system at a first time point; and
performing a wireless transmission using the second transmission rate with the access point at the second time point;
wherein the second transmission rate is determined by the access point using a transmission rate decision method, the transmission rate decision method comprises:
(a) at a first time point, obtaining a first packet error rate and a first transmission rate corresponding to a first current scene of the wireless transmission system;
(b) at the first time point, determining a first candidate packet error rate according to a first candidate transmission rate corresponding to a first candidate scene of the wireless transmission system; and
(c) determining a second transmission rate at a second time point according to the first packet error rate, the first transmission rate, the first candidate packet error rate and the first candidate transmission rate;
wherein the second time point lags behind the first time point.

16. The user device of claim 15, wherein the step (c) further comprises:
calculating a first throughput according to the first packet error rate and the first transmission rate;
calculating a first candidate throughput according to the first candidate packet error rate and the first candidate transmission rate; and
determining the second transmission rate at the second time point according to the first throughput and the first candidate throughput.

17. The user device of claim 16, wherein the step (c) further comprises:
determining that the second transmission rate is equal to the first transmission rate when the first throughput is greater than the first candidate throughput; and
determining that the second transmission rate is equal to the first candidate transmission rate when the first throughput is less than or equal to the first candidate throughput.

18. The user device of claim 15, wherein the first candidate transmission rate is smaller than the first transmission rate.

19. The user device of claim 17, wherein when the first throughput and the first candidate throughput are both less than a threshold, the transmission rate decision method further comprises:
(d) obtaining a second packet error rate corresponding to a second current scene of the wireless transmission system according to the second transmission rate and calculating a second throughput according to the second transmission rate and the second packet error rate at the second time point;
(e) obtaining an average throughput during a first time period corresponding to the wireless transmission system according to the first throughput and the second throughput at the second time point, wherein the first time period starts at the first time point and ends at the second time point;
(f) determining a second candidate packet error rate according to a second candidate transmission rate corresponding to a second candidate scene of the wireless transmission system and calculating a second candidate throughput according to the second candidate packet error rate and the second candidate transmission rate at the second time point; and
(g) determining a third transmission rate according to the average throughput and the second candidate throughput at a third time point;
wherein the wireless transmission system performs a wireless transmission using the third transmission rate at the third time point;
wherein the third time point lags behind the second time point.

20. The user device of claim 19, wherein the step (g) further comprises:
determining that the third transmission rate is equal to the second transmission rate when the average throughput is greater than the second candidate throughput; and
determining that the third transmission rate is equal to the second candidate transmission rate when the average throughput is less than or equal to the second candidate throughput.

21. The user device of claim 19, wherein the second candidate transmission rate is smaller than the second transmission rate, and a second candidate transmission bandwidth corresponding to the second candidate scene is smaller than a second transmission bandwidth corresponding to the second current scene.
